(19) United States
(12) Patent Application Publication
(10) Pub. No.: US 2008/0070581 A1
(43) Pub. Date: Mar. 20, 2008

(54) Apparatus, method, system and software product for a multicast service on a high speed transport channel using point-to-point and point-to-multipoint transmission

(76) Inventors: Gilles Charbit, Farnborough (GB); Kari Rikkinen, Il (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 11/811,277

(22) Filed: Jun. 7, 2007

Related U.S. Application Data
(60) Provisional application No. 60/812,381, filed on Jun. 8, 2006.

(51) Int. Cl. H04Q 7/20

(52) U.S. Cl. 455/450

(57) ABSTRACT

An apparatus, method, and software product are for a broadcast service or a multicast service by a point to multipoint transmission, for reception by a plurality of terminals. It is then determined whether reception by some of the terminals is substandard, and in those cases the multicast service is provided from the point via a point to point transmission. The point to multipoint transmission occurs at simultaneous times with each of the point to point transmissions, and the point to multipoint transmission uses a common downlink transport channel with the point to point transmissions.

### CROSS-REFERENCE TO RELATED APPLICATION

The present application claims priority to U.S. Provisional Application 60/812,381 filed Jun. 8, 2006.

### BACKGROUND OF THE INVENTION

1. Technical Field

The present invention pertains to the field of telecommunications. More particularly, the present invention pertains to a multicast service on a transport channel.

2. Discussion of Related Art

Release 6 of the Third Generation Partnership Project (3GPP) described various features of a Multimedia Broadcast Multicast Service (MBMS). This MBMS is described in 3GPP TR 25.992: “Multimedia Broadcast/Multicast Service (MBMS); UTRAN/GERAN requirements,” which is incorporated by reference herein.

According to Release 6, the MBMS is specified at the physical layer level in the following way, depending upon the number of users. For point-to-multipoint (p-t-m) transmission, the MBMS uses a Forward Access Transport Channel (FACH) mapped onto a Secondary Common Control Physical Channel (S-CCPCH). For point-to-point (p-t-p) transmission, the MBMS uses a Dedicated Transport Channel (DCH) mapped to a Dedicated Physical Data Channel (DPDCH).

According to Release 6, the MBMS is specified at the Medium Access Layer (MAC) level in the following way, depending upon the number of users. For the point-to-point (p-t-p) transmission scenario, the MBMS uses the Dedicated Control Logical Channel (DCCH) and Dedicated Traffic Logical Channel (DTCH). For the point-to-multipoint (p-t-m) transmission scenario, the MBMS point-to-multipoint (p-t-m) Control Logical Channel (MCCH) and MBMS p-t-m Traffic Logical Channel (MTCH) are used.

The Universal Mobile Telecommunications System (UMTS) Radio Terrestrial Radio Access Network (UTRAN) typically decides to use p-t-m transmission on the FACH transport channel if enough User Equipments (UEs) have joined to receive the same content, so as to make the use of the broadcast channel without power control sufficiently efficient. Otherwise, p-t-p transmission on the DCH transport channel is used.

The High-Speed Downlink Shared Transport Channel (HS-DSCH) in High Speed Downlink Packet Access (HSDPA) specified in Release 5 may also be used for p-t-p MBMS transmission by employing the Physical Downlink Shared Channel (PDSCH). In some cases, this transmission mode can be a more efficient way of transmitting the same signal for N users than using p-t-m MBMS transmission with the S-CCPCH on a FACH transport channel. According to a simple system analysis, the optimal switching point from using N parallel p-t-p connections on HS-DSCH to using one p-t-m connection on FACH is on the order of N=4-6 users, utilizing the International Telecommunications Union (ITU) Veh-A channel with no macrodiversity combining.

In 3GPP Release 6, a p-t-p MBMS transmission using a HighSpeed-Physical Downlink Shared Channel (HS-PDSCH) may employ Channel Quality Information (CQI) and Acknowledgment/Non-Acknowledgment (ACK/NACK) reported by the UE on the Uplink (UL), in order to perform Hybrid Acknowledgment Request (HARQ) re-transmission of erroneously transmitted data to improve performance. In p-t-m S-CCPCH MBMS, HARQ was not supported. However, it is possible to combine S-CCPCH MBMS data from a serving cell and another cell in a soft way (i.e. at symbol level before channel decoding) or a selective way (i.e. after channel decoding) in order to achieve macro-diversity performance gain.

As explained above, the decision to opt for a p-t-p transmission mode or a p-t-m transmission mode depends on the number of users receiving the MBMS content. There is also the likely scenario where a number of UEs may experience very poor reception relative to the majority of users. These UEs may need higher coding protection, more robust modulation, or re-transmission. However, these features were defined for HSDPA unicast service and may incur some efficiency loss if a p-t-m transmission mode is in use in the cell.

For example, a UE experiencing very significant fading may require a few HARQ re-transmissions in order to receive MBMS data with integrity. On the other hand, suppose that the other UEs in the cell do not themselves experience deep fading and suppose that the other UEs received the MBMS data with sufficient integrity (e.g. less than one per cent packet error rate). Those other UEs will not benefit significantly from MBMS data re-transmission. In this example, HARQ re-transmissions would clearly not be efficient with a p-t-m transmission mode. Likewise, using strong coding in a p-t-m transmission scenario to accommodate UEs that experience poor reception may be at the expense of causing a majority of UEs to experience stronger reception. These UEs might have received MBMS data encoded with weaker coding protection and yet still received data with sufficient integrity and at higher data rates (because coding overhead is less).

There is presently a need to find a mechanism that allows use of AMC and HARQ features for HS-PDSCH MBMS in order to assist UEs that experience deep fade, shadowing, or poor reception on the edge of the cell. These features are known to be spectrally efficient for unicast transmission, but they may incur some efficiency loss in broadcast or multicast scenarios.

### DISCLOSURE OF THE INVENTION

The present invention provides a way for the same HS-PDSCH connection to be shared by multiple users while still maintaining HS-PDSCH link features, such as link adaptation with Adaptive Modulation Coding (AMC) and HARQ (at least partly). Consequently, MBMS based upon HS-PDSCH becomes a competitive solution.

The present invention solves problems associated with MBMS transmission modes using an HS-DSCH transport channel, and provides a mechanism that allows use of AMC and HARQ features for HS-PDSCH MBMS in order to assist UEs that experience deep fade, shadowing, or poor reception on the edge of the cell.

### BRIEF DESCRIPTION OF THE DRAWINGS

FIG. 1 illustrates a first method according to an embodiment of the present invention, for implementation at the network side.

FIG. 2 illustrates a second method according to an embodiment of the present invention, for implementation at the terminal side.

FIG. 3 illustrates a system according to an embodiment of the present invention, including multiple mobile terminals and an apparatus at the network side.

### BEST MODE FOR CARRYING OUT THE INVENTION

An embodiment of the present invention will now be detailed with the aid of the accompanying figures. It is to be understood that this embodiment is merely an illustration of one particular implementation of the invention, without in any way foreclosing other embodiments and implementations.

According to one of the preferred embodiments of the invention, p-t-m transmission is used to provide a number of UEs with reception good enough to guarantee user satisfaction, for example 95 percent of p-t-m MBMS users in the sector getting 99 percent of packets received correctly.

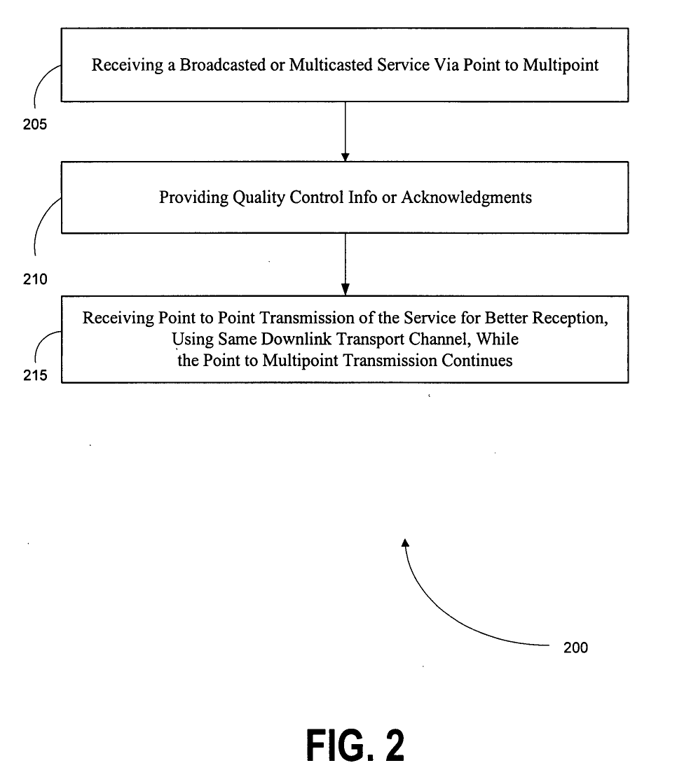

At the same time, according to this preferred embodiment, p-t-p transmission is provided to the other UEs in the cell which are experiencing poor reception. The FACH transport channel is not used. Both p-t-p and p-t-m MBMS transmission modes use the HS-DSCH transport channel, as shown in FIG. 2 which shows proposed transmission modes for HS-DSCH MBMS. The mechanism to assign UEs to the p-t-m HS-PDSCH MBMS transmission mode or p-t-p HS-PDSCH may be based on CQI measurements in the UE reported on the uplink (UL), and also ACK/NACKs reported by the UEs on the UL.

For example, a UE that reports CQI significantly lower than an average of CQI values reported by all the UEs in the cell may be deemed by the UTRAN network to require p-t-p HS-PDSCH transmission with the full benefit of AMC and HARQ. On the other hand, a UE with a CQI greater than the average CQI value in the cell may achieve the required user satisfaction (less than one per cent packet error rate) with p-t-m HS-PDSCH using fixed modulation and coding and no HARQ re-transmission. As a variant of this concept, the switching mechanism may be based on arbitrary threshold or statistical spread (e.g. variance) of CQI reporting.

Consider another example, wherein a UE sends many more NACK requests for re-transmission compared to an average number of NACK request from the UEs in the cell. The UTRAN network may decide that this UE may also require p-t-p HS-PDSCH transmission. UEs with a lower number of NACK requests may use p-t-m HS-PDSCH transmission.

The implementation of the present invention would only require software protocol development, mainly at the MAC layer and the physical layer levels. The impact on the Radio link Layer (RLC) and logical channels is likely to be minimal.

Advantages of the present invention include that it makes use of HSDPA mechanisms that have already been implemented, including CQI measurements and ACK/NACK requests from the UE on the UL, AMC and HARQ on the DL. The p-t-m HS-PDSCH transmission mode is a natural extension of the already-considered p-t-p HS-PDSCH transmission mode for MBMS, as an alternative to p-t-m S-CCPCH transmission mode.

The present invention further improves spectrum efficiency and enhanced bit rates using the HS-DSCH transport channel, as compared to Release 6 MBMS based upon S-CCPCH in Release 6. The present invention has high relevance to mobile TV (broadcast and multicast) in the third generation (3G) evolution, and will help complement other mobile TV standards as well, including a variety of digital video systems.

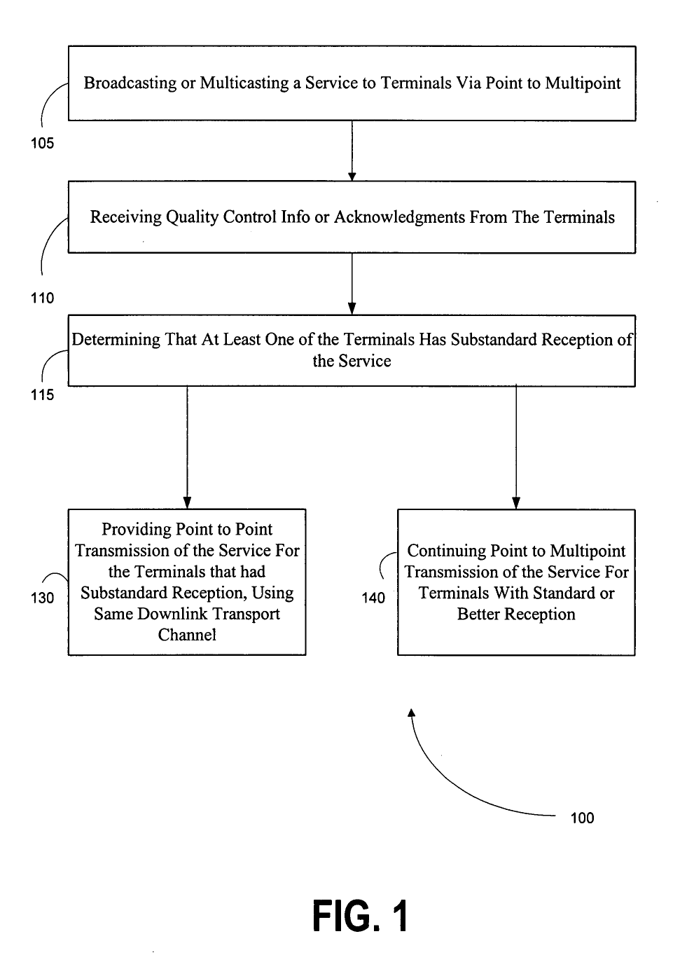

Referring now to the figures, FIG. 1 illustrates a method 100 according to an embodiment of the present invention, for implementation at the network side. A service is broadcasted or multicasted 105 to various terminals via point-to-multipoint (p-t-m) transmission. Then, quality control information, or negative acknowledgments, or positive acknowledgments, are received 110 from the terminals in order to indicate the quality of reception of the p-t-m transmission. Using this received information, it is then determined 115 that one or more of the terminals has substandard reception of service. Subsequently, a point-to-point (p-t-p) transmission of the service is provided 130 to those terminals that were determined to have substandard reception, using the same downlink transport channel as for the p-t-m transmission. Meanwhile, the p-t-m transmission of the service continues 140 for terminals with standard or better reception.

Turning now to FIG. 2, this figure illustrates a method 200 according to an embodiment of the present invention, for implementation at the terminal side. A broadcasted or multicasted service is received 205 via a p-t-m transmission. Then the terminal provides 210 quality control information or acknowledgments (negative or positive) indicating the quality of the reception of the service. Then, a point-to-point transmission of the service is received 215 to provide better reception, using the same downlink transport channel, and while the point-to-multipoint transmission continues on that common channel.

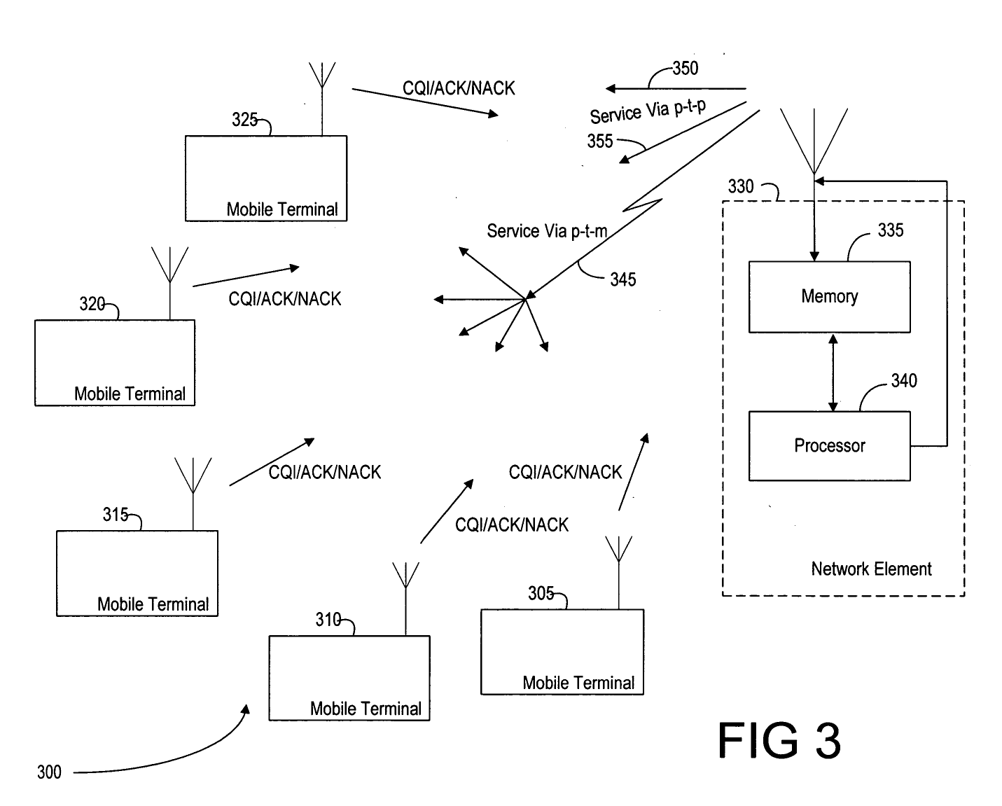

FIG. 3 illustrates a system 300 according to an embodiment of the present invention. Mobile terminals 305-325 receive a service via a p-t-m transmission 345 from network element 330. In response, the mobile terminals provide feedback indicating how well the service was received, and this feedback may be, for example, quality control information or positive acknowledgments or negative acknowledgments (CQI/ACK/NACK). This feedback is initially collected and stored in a memory 335 within the network element 330. Subsequently, the collected information is analyzed by the processor 340 within the network element 330. The processor will then instruct that a p-t-p service 350 and 355 be provided respectively to certain terminals 320 and 325 for which reception has been determined to be substandard.

The present invention also includes a software product for performing the embodiment of the method described above, and the software can be implemented using a general purpose or specific-use computer system, with standard operating system software conforming to the method described herein. The software is designed to drive the operation of the particular hardware of the system, and will be compatible with other system components and I/O controllers. The computer system of this embodiment includes a CPU processor such as processor 340 shown in FIG. 3, comprising a single processing unit, multiple processing units capable of parallel operation, or the CPU can be distributed across one or more processing units in one or more locations, e.g., on a client and server, or within other components. The memory such as memory 335 shown in FIG. 3 may comprise any known type of data storage and/or transmission media, including magnetic media, optical media, random access memory (RAM), read-only memory (ROM), a data cache, a data object, or the like. Moreover, similarly to the CPU, the memory may reside at a single physical location, comprising one or more types of data storage, or be distributed across a plurality of physical systems in various forms.

It is to be understood that all of the present figures, and the accompanying narrative discussions of corresponding embodiments, do not purport to be completely rigorous treatments of the method, apparatus, system, and software product under consideration. A person skilled in the art will understand that the steps and signals of the present application represent general cause-and-effect relationships that do not exclude intermediate interactions of various types, and will further understand that the various steps and structures described in this application can be implemented by a variety of different sequences and configurations, using various combinations of hardware and software which need not be further detailed herein.

What is claimed is:

1. A method comprising:
broadcasting or multicasting a service by a point to multipoint transmission, for reception by a plurality of terminals;
determining that reception by at least one of the terminals is substandard; and
providing the service via a point to point transmission for the at least one of the terminals that has experienced substandard reception;
wherein the point to multipoint transmission to terminals experiencing standard or above-standard reception continues at simultaneous times with the point to point transmissions; and
wherein the point to multipoint transmission and the point to point transmissions use a common downlink transport channel.

2. The method of claim 1, wherein the substandard determination is based on quality control information that is reported on an uplink from the at least one of the terminals.

3. The method of claim 1, wherein the substandard determination is based on positive or negative acknowledgments reported on an uplink from the at least one of the terminals.

4. The method of claim 1, wherein the substandard determination is based on quality control information that is reported on an uplink from the at least one of the terminals, and the quality control information indicates quality that is substantially lower than an average for terminals that share a cell with the at least one of the terminals.

5. The method of claim 1,
wherein the substandard determination is based on positive or negative acknowledgments reported on an uplink from the at least one of the terminals, and
wherein the negative acknowledgments are more numerous than an average for terminals that share a cell with the at least one of the terminals.

6. The present invention also includes a computer readable medium encoded with a software data structure for performing the method of claim 1.

7. A method comprising:
receiving a broadcasted or multicasted service via a point to multipoint transmission; and,
subsequently receiving the service via a point to point transmission for improved reception;
wherein the point to multipoint transmission continues to use a common downlink transport channel with the point to point transmission.

8. The method of claim 7, wherein use of the point to point transmission is in response to quality control information that is reported on an uplink.

9. The method of claim 7, wherein use of the point to point transmission is in response to positive or negative acknowledgments reported on an uplink.

10. The method of claim 7,
wherein use of the point to point transmission is in response to quality control information that is reported on an uplink, and
wherein the quality control information indicates quality that is substantially lower than an average for a plurality of terminals that share a cell.

11. The method of claim 7,
wherein use of the point to point transmission is in response to positive or negative acknowledgments reported on an uplink, and
wherein the negative acknowledgments are more numerous than an average for a plurality of terminals that share a cell.

12. A computer readable medium encoded with a software data structure for performing the method of claim 7.

13. An apparatus or network element comprising:
a memory configured to store information from a plurality of terminals; and
a processor, responsive to the information from the memory unit, the processor being configured to determine whether reception of a broadcasted or multicasted service via a point to multipoint transmission is substandard for at least one of the terminals;
wherein the processor is further configured to initiate a point to point transmission of the service to the at least one of the terminals for which the point to multipoint transmission is substandard;
wherein the point to multipoint transmission to terminals experiencing standard or above-standard reception continues at simultaneous times with the point to point transmissions; and
wherein the point to multipoint transmission and the point to point transmissions use a common downlink transport channel.

14. The apparatus or network element of claim 13, wherein the information is quality control information.

15. The apparatus or network element of claim 13, wherein the information comprises positive or negative acknowledgments.

16. The apparatus or network element of claim 13,
wherein the information is quality control information, and
wherein the quality control information indicates quality that is substantially lower for the at least one of the terminals compared to an average for terminals that share a cell with the at least one of the terminals.

17. The apparatus or network element of claim 13, wherein the information comprises positive or negative acknowledgments, and the negative acknowledgments are more numerous than an average for terminals that share a cell with the at least one of the terminals.

18. An apparatus or network element comprising:
means for storing information from a plurality of terminals; and
means for determining, responsive to the information from the storing means, whether reception of a broadcasted or multicasted service via a point to multipoint transmission is substandard for at least one of the terminals;
wherein the determining means is also for initiating a point to point transmission of the service to the at least one of the terminals for which the point to multipoint transmission is substandard;
wherein the point to multipoint transmission to terminals experiencing standard or above-standard reception continues at simultaneous times with the point to point transmissions; and
wherein the point to multipoint transmission and the point to point transmissions use a common downlink transport channel.

19. The apparatus or network element of claim 18, wherein the information is quality control information.

20. The apparatus or network element of claim 18, wherein the information comprises positive or negative acknowledgments.

21. A computer program product including a computer-readable medium having computer-executable components comprising:
a component for determining that reception, of a broadcasted or multicasted service received via a point to multipoint transmission by at least one of a plurality of terminals, is substandard; and
a component for providing the service via a point to point transmission for reception by each of the at least one of the plurality of terminals that experience substandard reception;
wherein the point to multipoint transmission to terminals experiencing standard or above-standard reception continues at simultaneous times with the point to point transmissions; and
wherein the point to multipoint transmission and the point to point transmission use a common downlink transport channel.

22. The computer program product of claim 21, wherein the substandard determination is based on quality control information that is reported on an uplink from the at least one of the terminals.

23. The computer program product of claim 21, wherein the substandard determination is based on positive or negative acknowledgments reported on an uplink from the at least one of the terminals.

24. An system comprising:
a plurality of terminals configured to provide information to a network;
a network element having a memory configured to store information from the plurality of terminals, and also having a processor, responsive to the information from the memory unit,
wherein the processor is configured to determine whether reception of a broadcasted or multicasted service via a point to multipoint transmission is substandard for at least one of said plurality of terminals;
wherein the processor is further configured to initiate a point-to-point transmission of the service to the at least one of the terminals for which the point-to-multipoint transmission is substandard;
wherein the point-to-multipoint transmission to terminals experiencing standard or above-standard reception continues at simultaneous times with the point-to-point transmissions; and
wherein the point to multipoint transmission and the point-to-point transmissions use a common downlink transport channel.

25. The system of claim 24, wherein the information is quality control information.

26. The system of claim 24, wherein the information comprises positive or negative acknowledgments.

27. The system of claim 24,
wherein the information is quality control information, and
wherein the quality control information indicates quality that is substantially lower for the at least one of the terminals compared to an average for terminals that share a cell with the at least one of the terminals.

28. The system of claim 24, wherein the information comprises positive or negative acknowledgments, and the negative acknowledgments are more numerous than an average for terminals that share a cell with the at least one of the terminals.

29. A computer chip configured to perform the method of claim 1.

30. An integrated circuit configured to perform the method of claim 1.
